(19) United States
(12) Patent Application Publication
(10) Pub. No.: US 2026/0203100 A1
(43) Pub. Date: Jul. 16, 2026

(54) AUGMENTED VIRTUAL ASSISTANCE CHATBOT USING QUANTUM MULTI-MODAL KNOWLEDGE GRAPH

(71) Applicant: Bank of America Corporation, Charlotte, NC (US)

(72) Inventors: Pushkar Taneja, Hyderabad Telangana (IN); Suryanarayana Adivi, Hyderabad Telangana (IN); Shailendra Singh, Maharashtra (IN); Jemlin Lucas, Addison, TX (US); Yash Pant Dashputra, Hyderabad Telangana (IN)

(21) Appl. No.: 19/017,959

(22) Filed: Jan. 13, 2025

(51) Int. Cl. G06F 9/48

(52) U.S. Cl. CPC G06F 9/4881

(57) ABSTRACT

Systems and methods for optimizing an online chatbot platform are provided. A method may include generating a database of computing jobs associated with chatbot requests and identifying, for each job, a set of features that may include a priority level, a criticality level, a sensitivity level, a set of resources required for the job and a utilization rate for each such resource, and prerequisite interdependencies with other jobs in the database. Features in the set may include structured data and/or unstructured data. The method may include generating a multi-modal knowledge graph representing the database of computing jobs and the set of features for each job in the database. The method may include receiving a series of requests via the online chatbot platform, generating a list of runtime jobs to address the requests, and generating an optimized sequence for running the runtime jobs.

### FIELD OF TECHNOLOGY

Aspects of the disclosure relate to computer systems. Specifically, aspects of the disclosure relate to optimization of chatbot systems.

### BACKGROUND OF THE DISCLOSURE

The rapid advancement of artificial intelligence (AI) and machine learning (ML) has enabled the development of conversational chatbots capable of simulating human-like interactions across various applications. These systems have found utility in customer support and virtual assistance across disparate fields such as healthcare, education, entertainment, and the financial sector.

Conversational chatbots may leverage natural language processing (NLP) and ML techniques, particularly neural networks, to understand user inputs, generate coherent responses, and engage in meaningful dialogues.

Despite significant progress, existing chatbot technologies often face efficiency challenges. For example, chatbots may receive thousands if not millions of requests in a short amount of time, and processing the requests may overload system resources. This may cause delays and/or system outages.

It would be desirable, therefore, to provide systems and methods for optimized chatbot platforms.

### SUMMARY OF THE DISCLOSURE

Aspects of the disclosure relate to an optimized online chatbot platform. The platform may be configured to use historical data to generate a database of computing jobs, or tasks. For each job in the database of computing jobs, the platform may be configured to identify a set of features.

The set of features may include at least a priority level, a criticality level, a sensitivity level, a set of resources required for the job and a utilization rate for each such resource, and prerequisite interdependencies with other jobs in the database of computing jobs. At least one of the features in the set of features may include structured data and at least one of the features in the set of features may include unstructured data.

The platform may be configured to generate, via a machine-learning (ML) model, a multi-modal knowledge graph representing the database of computing jobs and the set of features for each job in the database of computing jobs.

The platform may be configured to receive, at a central server, a series of requests via the online chatbot platform, and to generate, via the ML model, a list of runtime jobs to address the series of requests.

The platform may be configured to generate, via a processor using the multi-modal knowledge graph, an optimized sequence for running the runtime jobs.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative apparatus in accordance with principles of the disclosure;

FIG. 3 shows an illustrative diagram in accordance with principles of the disclosure;

FIGS. 4A-4B show an illustrative diagram in accordance with principles of the disclosure;

FIGS. 5A-5B show illustrative diagrams in accordance with principles of the disclosure; and

FIG. 6 shows an illustrative diagram in accordance with principles of the disclosure.

### DETAILED DESCRIPTION OF THE DISCLOSURE

Aspects of the disclosure relate to systems and methods for an optimized online chatbot platform. The platform may include a central server, a machine-learning (ML) model, a processor, and computer executable instructions that, when run on the processor, may be configured to implement system features or execute method steps. System (which may be referred to herein as a “platform”) features and configurations may, in certain embodiments, correspond to steps of the methods.

The platform may be configured to use historical data to generate a database of computing jobs. A computing job may be a computing task. A computing task may include running a specific code sequence, which may include processing and/or storing information.

For each job in the database of computing jobs, the platform may be configured to identify a set of features. The set of features may include one or more of a priority level (i.e., how quickly a task must be executed), a criticality level (i.e., how critical a task is to the overall system), a sensitivity level (i.e., a level of sensitivity or confidentiality of information included or processed in the task), a set of resources required for the job and a utilization rate for each such resource, and prerequisite interdependencies with other jobs in the database of computing jobs. The set of features may be dynamically updated in real-time. For example, the platform may continuously monitor the system resources and execution of computing tasks and update the set of features accordingly.

At least one of the features in the set of features may include structured data and at least one of the features in the set of features may include unstructured data. Structured data may include quantitative data. Structured data may fit neatly into data tables and includes discrete data types such as numbers, short text, and dates. Unstructured data may include qualitative data. Unstructured data may not fit neatly into a data table due to its size or nature (e.g., audio and video files, large text documents, sensor data, node/edge structure, etc.). As an illustrative example, the priority level may be represented in the set of features as a number from 1-10 (this may be structured) while the prerequisite interdependencies with other jobs in the database may be represented as a graph with interconnected nodes and edges (this may be unstructured).

The platform may be configured to generate, via the ML model, a multi-modal knowledge graph representing the database of computing jobs and the set of features for each job in the database of computing jobs. A multi-modal knowledge graph may be a knowledge graph storing data in a plurality of modalities, including different data types. See, for example, the academic article “What Is a Multi-Modal Knowledge Graph: A Survey” (published at Big Data Research, Volume 32, 2023, 100380, ISSN 2214-5796, accessible at https://doi.org/10.1016/j.bdr.2023.100380), which is hereby incorporated by reference herein in its entirety. This approach may allow for the representation and integration of various data types, such as structured, semi-structured, and unstructured data, within a single knowledge graph.

The platform may be configured to receive, at the central server, a series of requests via the online chatbot platform. In some embodiments, the series of requests may originate from a plurality of users. Each user may, for example, be accessing an online application connected to the online chatbot platform. A request may be received via a text input. A request may be received via voice input. Natural language processing (NLP) may be used in processing the requests.

The platform may be configured to generate, via the ML model, a list of runtime jobs to address the series of requests. Addressing a request may, for example, include responding to a query. Responding to a query may include generating language for a response and/or transmitting the response to a user. The response may include a web-based link. Responding to a query may include executing a transaction.

In some embodiments, generating the list of runtime jobs to address the series of requests may include using NLP to extract an intent from each request. The platform may be configured to receive text-based requests. The platform may be configured to receive voice-based requests.

The platform may be configured to generate, via the processor using the multi-modal knowledge graph, an optimized sequence for running the runtime jobs. The optimized sequence may reflect a sequence that best balances the set of features (i.e., priority level, criticality level, sensitivity level, set of resources required for the job and utilization rate for each such resource, and prerequisite interdependencies with other jobs in the database) of each job.

The platform may be configured to generate, via the processor using the multi-modal knowledge graph, an optimized resource allocation plan for running the runtime jobs. The optimized resource allocation plan may reflect a resource allocation that best balances the set of features (i.e., priority level, criticality level, sensitivity level, set of resources required for the job and utilization rate for each such resource, and prerequisite interdependencies with other jobs in the database) of each job.

After running the runtime jobs according to the optimized sequence and/or the optimized resource allocation plan, the platform may be configured to feed performance data of the running of the runtime jobs to the ML model. The platform may be configured to analyze the performance data via the ML model. The platform may be configured to adjust the multi-modal knowledge graph (e.g., adjust the information and/or the connections stored therein) in response to the analysis.

In some embodiments, the platform may be configured to generate, via the processor using the multi-modal knowledge graph, a job completion prediction for running the runtime jobs. The job completion prediction may include a time component (e.g., how much time it will take to complete one or more of the jobs) and a resource utilization component (e.g., amount of resources utilized to complete one or more of the jobs).

After running the runtime jobs according to the optimized sequence and/or the optimized resource allocation plan, the platform may be configured to feed performance data of the running of the runtime jobs to the ML model. The platform may be configured to analyze, via the ML model, the performance data vis-à-vis the job completion prediction. The platform may be configured to adjust the multi-modal knowledge graph (e.g., adjust the information and/or the connections stored therein) in response to the analysis.

In some embodiments, the processor may include a quantum computer. Quantum computing may be referred to as the use of quantum-mechanical phenomena such as superposition, entanglement, and interference to perform computations. Superposition may refer to a quantum bit (qubit) being in multiple states simultaneously. Entanglement may describe a linked relationship between multiple qubits where the state of one instantly affects the state of the others. Interference may be the phenomenon where quantum states can interact with each other, either reinforcing or canceling out possibilities, leading to specific outcomes in a calculation. The qubit may be the smallest bit in a quantum computer.

The amount, and type, of calculations that a quantum computer may be able to process may grow exponentially with the number of qubits included in the quantum computer's processing core. A quantum computer with “N” qubits may be able to simultaneously represents 2ⁿ states. Therefore, two qubits may hold four states, three qubits may hold eight states, fifty qubits may hold 1,125,899,906,842,624 states, and 10,000 qubits may hold 2¹⁰⁰⁰⁰ states.

Quantum processors are associated with vastly improved efficiencies over classical computers. For example, whereas classical computers represent data in bits, which can be either 0 or 1, quantum processors use qubits which utilize superposition (i.e., the ability to be in multiple states at the same time until it measured) to allow for a state of 0, 1, or any probability of being 0 or 1.

The probabilities can be manipulated using matrix-based quantum gates, which are analogous to classical logic gates. Qubits are therefore able to represent many more data possibilities than a bit-based system of the same size. This allows for greater speed and less memory usage than classical systems.

A qubit in a state of superposition does not have a defined value because it may hold many potential values at the same time. When measured, the qubit wave function collapses to a defined state. When an entangled qubit is in a state of superposition, each of its entangled connections is also in a state of superposition. These combinations of uncertainties may exponentially increase the power of quantum computers.

The quantum processor may include a default number of quantum threads. Each quantum thread may include a default number of quantum circuits. Quantum circuits, in turn, may refer to hardware and software based computational models that include quantum gates and are used for executing quantum computations.

For example, at least one of the quantum circuits may include a Toffoli gate. A feature of the Toffoli gate is its universal nature, i.e., it is able to represent classical computer operations as well as quantum operations. At least one of the quantum circuits may include a Hadamard gate. A feature of the Hadamard gate is the ability to represent a superposition state.

Leveraging advantages of quantum computing, such as superposition, entanglement, and interference, to handle and process vast amounts of data simultaneously (i.e., in parallel) may be especially useful in conjunction with aspects of the disclosed chatbot platform to efficiently handle large amounts of requests and the resultant computing jobs associated with those requests.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

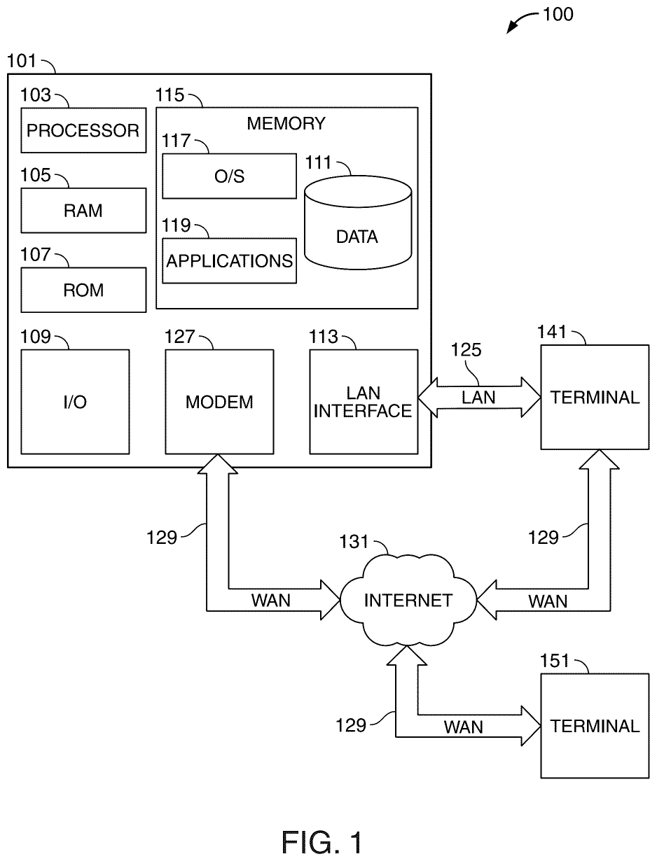

FIG. 1 shows an illustrative block diagram of system 100 that includes computer 101. Computer 101 may alternatively be referred to herein as a “server” or a “computing device.” Computer 101 may be a workstation, desktop, laptop, tablet, smart phone, or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may comprise any suitable permanent storage technology—e.g., a hard drive. The memory 115 may store software including the operating system 117 and application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 101 may execute the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input may relate to chatbot requests and processing thereof. The input/output module may also include one or more speakers for providing audio output and a video display device for providing textual, audio, audiovisual, and/or graphical output. The input and output may be related to computer application functionality. The input and output may be related to chatbot requests and processing thereof.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking user functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking user functionality related to performing various tasks. The various tasks may be related to chatbot requests and processing thereof.

Computer 101 and/or terminals 141 and 151 may also be devices including various other components, such as a battery, speaker, and/or antennas (not shown).

Terminal 151 and/or terminal 141 may be portable devices such as a laptop, cell phone, Blackberry TM, tablet, smartphone, or any other suitable device for receiving, storing, transmitting and/or displaying relevant information. Terminals 151 and/or terminal 141 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

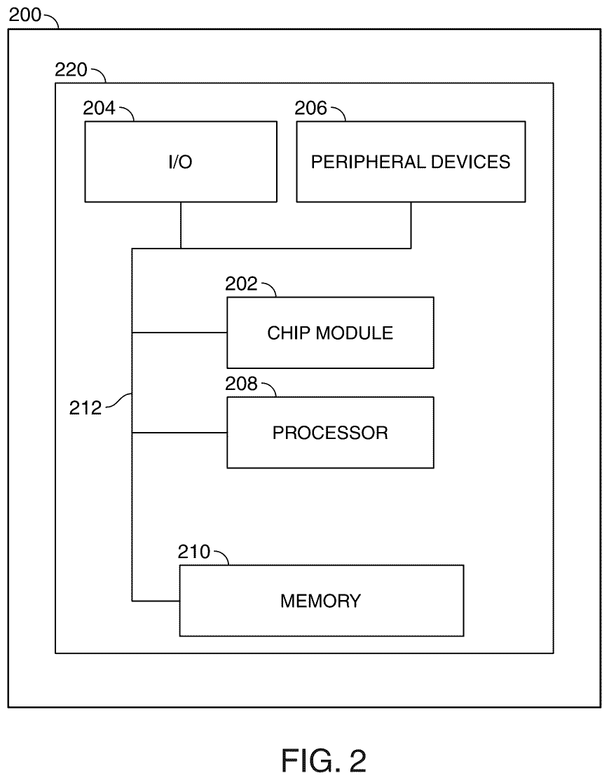

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer instructions” or “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

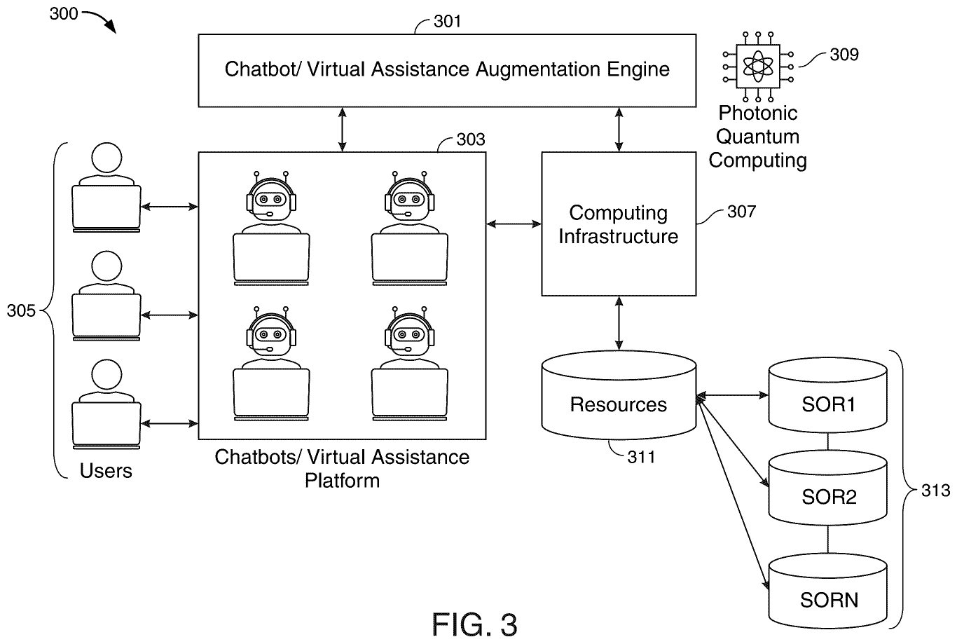

FIG. 3 shows illustrative diagram 300 in accordance with aspects of the disclosure. Users 305 may interact with chatbots 303 and submit requests. Chatbot optimization engine 301 may leverage computing infrastructure 307, which may include quantum computer 309, to optimize execution of the requests. Optimizing execution of the requests may include generating and implementing an optimized runtime job sequence, and an optimized resource allocation plan, for running computing jobs necessitated by the requests. The resource allocation plan may include allocation of resources 311 and Systems of Record (SOR) 303. An SOR may be a data management term for a computer system that stores and manages information, which may be a high-priority system that serves as the authoritative source for critical data.

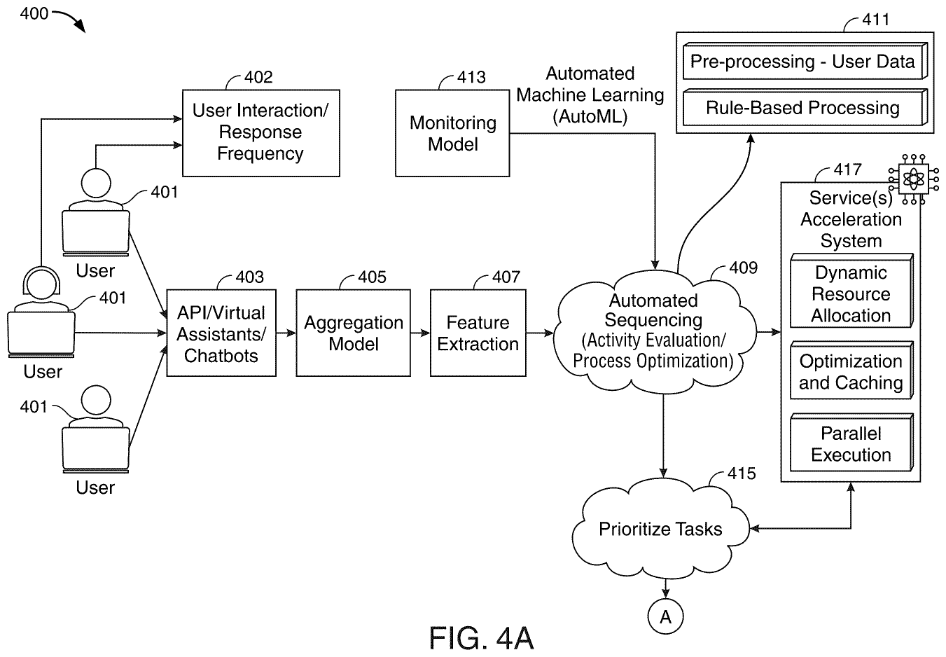

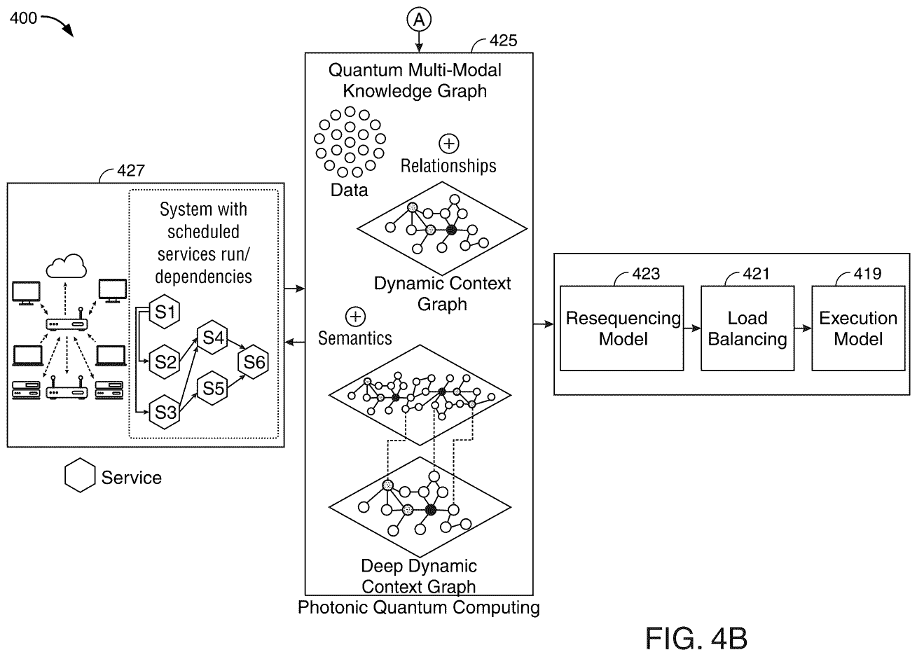

FIGS. 4A-4B show illustrative diagram 400 in accordance with aspects of the disclosure. Users 401 may interact with chatbots 403. The interactions may include requests. The requests may be associated with frequencies 402. Aggregation model 405 may aggregate the request and extract intents from the requests at feature extraction 407. The optimization engine may leverage automated machine learning and monitoring model 413 to process the requests at 411 and to generate (i) an optimized sequencing 409, including task prioritization 415, and (ii) dynamic resource allocation, optimization and caching, and parallel execution at 417.

The optimization engine may include multi-modal knowledge graph (MMKG) 425 (which may include or be run on a quantum computer) which may represent data interconnected in deep dynamic context graphs (i.e., the graph may show multiple layers of interconnected data that may change in real time). MMKG 425 may include data relating to prerequisite dependencies 427 among computing jobs. The optimization system may generate an execution sequence 423 and a load balancing (i.e., optimized resource allocation) that may be included in execution model 419. MMKG 425 may apply semantics to provide deeper context to connected data, providing more powerful insights from the connected data.

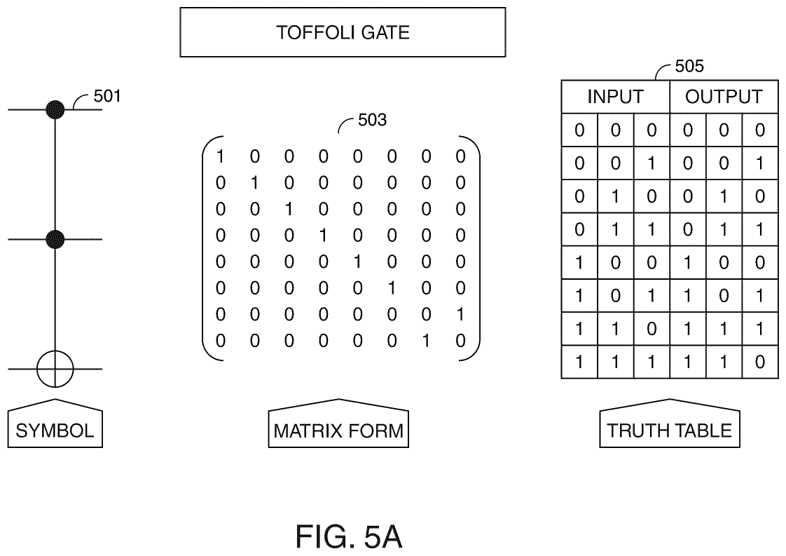

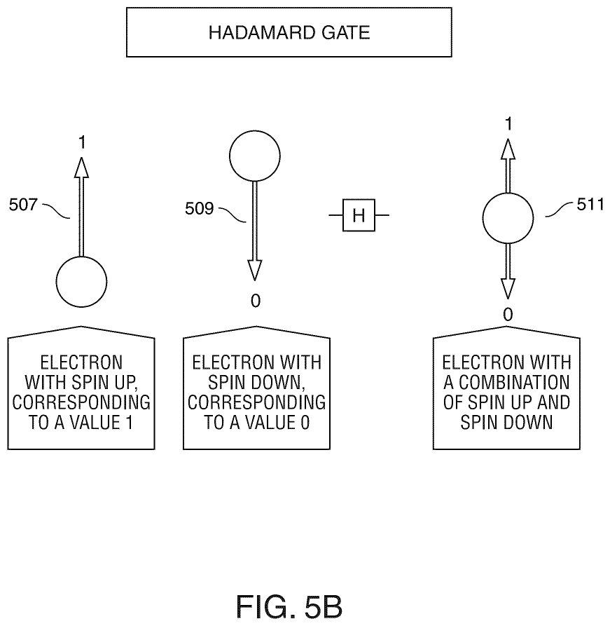

FIGS. 5A-5B show illustrative diagrams of exemplary quantum gates in accordance with principles of the disclosure. FIG. 5A shows symbol 501, matrix form 503, and truth table 505 of a Toffoli gate. A Toffoli gate is a universal reversible logic gate, which means that it enables simulation of any classical reversible circuit. In operation, as seen in truth table 505, the exemplary Toffoli gate has a 3-bit input and a 3-bit output. The first two output bits always mirror the first two input bits. The third bit also stays the same unless the first two input bits are both set to 1—in which case the third output bit is inverted from the third input bit. The Toffoli gate is therefore also known as the “controlled-controlled-not” gate.

FIG. 5B shows representations of a Hadamard gate. Symbol 507 shows a representation of electron spin up, which corresponds to the value 1. Symbol 509 shows a representation of electron spin down, which corresponds to the value 0. Symbol 511 shows a representation of electron spin up and down, which corresponds to the value that represents a superposition of 1 and 0.

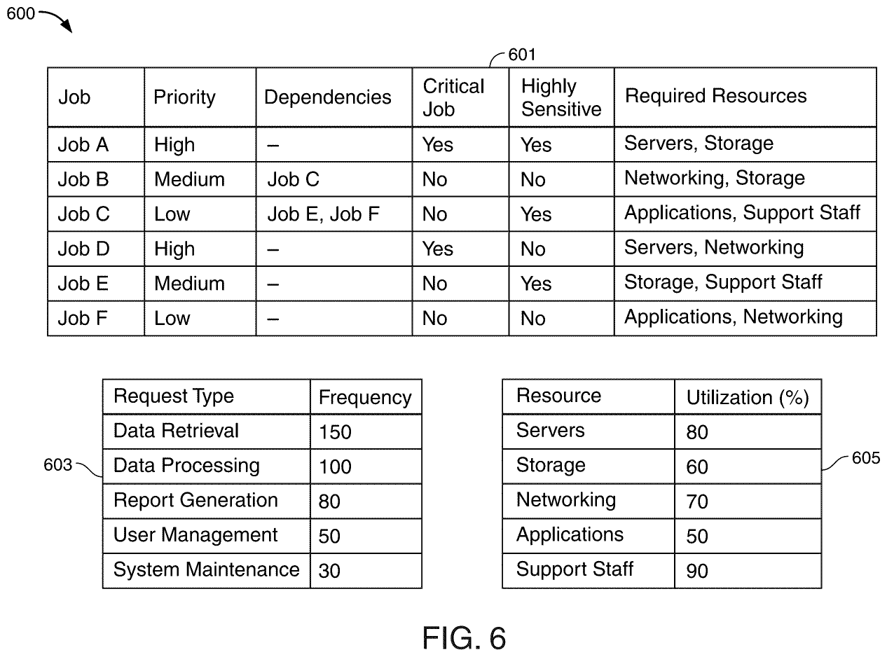

FIG. 6 shows illustrative diagram 600 in accordance with aspects of the disclosure. Table 601 may include a database of various computing jobs (column 1), and for each job, store a set of features including priority level (column 2), dependencies (column 3), criticality (column 4), sensitivity (column 5), and required resources (column 6). Table 603 may include a level of frequency associated with each of a set of request types (each request which may be associated with one or more computing jobs). Table 605 may include a resource utilization level for each of a set of resource usages. The MMKG may include the information shown in tables 601, 603, and 605. Connecting such data, even when presented in a plurality of data modalities, may help provide a depth to the data insights that may be leveraged to optimize the chatbot system.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for optimized online chatbot platforms are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for optimizing an online chatbot platform, the method comprising:
using historical data to generate a database of computing jobs associated with chatbot requests;
for each job in the database of computing jobs, identifying a set of features, wherein:
the set of features comprises at least a priority level, a criticality level, a sensitivity level, a set of resources required for the job and a utilization rate for each such resource, and prerequisite interdependencies with other jobs in the database of computing jobs;
at least one of the features in the set of features comprises structured data and at least one of the features in the set of features comprises unstructured data; and
the set of features is dynamically updated in real-time;
generating, via a machine-learning (ML) model, a multi-modal knowledge graph representing the database of computing jobs and the set of features for each job in the database of computing jobs;
receiving, at a central server, a series of requests via the online chatbot platform;
generating, via the ML model, a list of runtime jobs to address the series of requests; and
generating, via a processor of the central server using the multi-modal knowledge graph, an optimized sequence for running the runtime jobs.

2. The method of claim 1 further comprising generating, via the processor using the multi-modal knowledge graph, an optimized resource allocation plan for running the runtime jobs.

3. The method of claim 2 further comprising, after running the runtime jobs according to the optimized sequence and the optimized resource allocation plan:
feeding performance data of the running of the runtime jobs to the ML model;
analyzing the performance data via the ML model; and
adjusting the multi-modal knowledge graph in response to the analysis.

4. The method of claim 1 further comprising generating, via the processor using the multi-modal knowledge graph, a job completion prediction for running the runtime jobs, said job completion prediction comprising a time component and a resource utilization component.

5. The method of claim 4 further comprising, after running the runtime jobs according to the optimized sequence:
feeding performance data of the running of the runtime jobs to the ML model;
analyzing, via the ML model, the performance data vis-à-vis the job completion prediction; and
adjusting the multi-modal knowledge graph in response to the analysis.

6. The method of claim 1 wherein generating the list of runtime jobs to address the series of requests comprises using natural language processing to extract an intent from each request.

7. The method of claim 6 wherein at least one of the requests was received in text-based form.

8. The method of claim 6 wherein at least one of the requests was received in voice-based form.

9. The method of claim 1 wherein the series of requests originate from a plurality of users, each user accessing an online application connected to the online chatbot platform.

10. The method of claim 1 wherein the processor comprises a quantum computer.

11. An optimized online chatbot platform, the platform comprising a central server, a machine-learning (ML) model, a processor, and computer executable instructions that, when run on the processor, are configured to:
use historical data to generate a database of computing jobs;
for each job in the database of computing jobs, identify a set of features, wherein:
the set of features comprises at least a priority level, a criticality level, a sensitivity level, a set of resources required for the job and a utilization rate for each such resource, and prerequisite interdependencies with other jobs in the database of computing jobs;
at least one of the features in the set of features comprises structured data and at least one of the features in the set of features comprises unstructured data; and
the set of features is dynamically updated in real-time;
generate, via the ML model, a multi-modal knowledge graph representing the database of computing jobs and the set of features for each job in the database of computing jobs;
receive, at the central server, a series of requests via the online chatbot platform;
generate, via the ML model, a list of runtime jobs to address the series of requests; and
generate, via the processor using the multi-modal knowledge graph, an optimized sequence for running the runtime jobs.

12. The platform of claim 11 further configured to generate, via the processor using the multi-modal knowledge graph, an optimized resource allocation plan for running the runtime jobs.

13. The platform of claim 12 further configured to, after running the runtime jobs according to the optimized sequence and the optimized resource allocation plan:
feed performance data of the running of the runtime jobs to the ML model;
analyze the performance data via the ML model; and
adjust the multi-modal knowledge graph in response to the analysis.

14. The platform of claim 11 further configured to generate, via the processor using the multi-modal knowledge graph, a job completion prediction for running the runtime jobs, said job completion prediction comprising a time component and a resource utilization component.

15. The platform of claim 14 further configured to, after running the runtime jobs according to the optimized sequence:
feed performance data of the running of the runtime jobs to the ML model;
analyze, via the ML model, the performance data vis-à-vis the job completion prediction; and
adjust the multi-modal knowledge graph in response to the analysis.

16. The platform of claim 11 wherein generate the list of runtime jobs to address the series of requests comprises using natural language processing to extract an intent from each request.

17. The platform of claim 16 wherein at least one of the requests was received in text-based form.

18. The platform of claim 16 wherein at least one of the requests was received in voice-based form.

19. The platform of claim 11 wherein the series of requests originate from a plurality of users, each user accessing an online application connected to the online chatbot platform.

20. The platform of claim 11 wherein the processor comprises a quantum computer.
